(19) United States
(12) Patent Application Publication
(10) Pub. No.: US 2024/0333435 A1
(43) Pub. Date: Oct. 3, 2024

(54) METHOD FOR COOPERATIVE RETRANSMISSION IN AN OMAMRC SYSTEM

(71) Applicant: Orange, Issy-Les-Moulineaux (FR)

(72) Inventor: Raphaël VISOZ, Chatillon Cedex (FR)

(21) Appl. No.: 18/575,593

(22) PCT Filed: Jun. 27, 2022
(86) PCT No.: PCT/FR2022/051266

§ 371 Date: Dec. 29, 2023

(30) Foreign Application Priority Data
Jul. 1, 2021 (FR) 2107151

(51) Int. Cl. H04L 1/1812; H04L 1/00; H04L 1/20; H04L 12/18

(52) U.S. Cl. CPC H04L 1/1819; H04L 1/206; H04L 12/1868; H04L 2001/0097

(57) ABSTRACT

A transmission method for an OMAMRC telecommunication system with M sources (S₁, . . . , S_{M}), optionally L relays and a destination, M≥2, L≥0. In such a solution, when a source was unable to be decoded by the destination, the latter organises a simultaneous retransmission, by the set of nodes in the system that decoded the source, of a message transmitted by the latter.

### CROSS-REFERENCE TO RELATED APPLICATIONS

This application is filed under 35 U.S.C. § 371 as the U.S. National Phase of Application No. PCT/FR2022/051266 entitled “METHOD FOR COOPERATIVE RETRANSMISSION IN AN OMAMRC SYSTEM” and filed Jun. 27, 2022, and which claims priority to FR 2107151 filed Jul. 1, 2021, each of which is incorporated by reference in its entirety.

### BACKGROUND

### Field

The present development relates to the domain of digital communications. Within this field, the development relates more particularly to the transmission of coded data between at least two sources and a destination with a relaying by at least two nodes which may be relays or sources.

It is understood that a relay does not have any message to transmit. A relay is a node dedicated to relaying messages from sources, whereas a source has its own message to transmit and can also, in some cases, relay the messages from the other sources, i.e. the source is referred to as cooperative in this case.

There are many different relay techniques: “amplify and forward”, “decode and forward”, “compress-and-forward”, “non-orthogonal amplify and forward”, “dynamic decode and forward”, etc.

The development applies in particular, but not exclusively, to data transmission via mobile networks, for example for real-time applications, or via sensor networks, for example.

Such a sensor network is a multi-user network, comprised of several sources, several relays and a recipient using an orthogonal multiple access scheme of the transmission channel between the relays and the destination, referred to as OMAMRC (“Orthogonal Multiple-Access Multiple-Relay Channel”).

Subsequently, the orthogonality between source and relay transmissions is achieved by a time multiplexing in the form of disjointed time slots. It is also possible to generalise to an orthogonality resulting from a frequency multiplexing in the form of disjointed frequency sub-bands.

### Prior Art and its Disadvantages

An OMAMRC transmission system implementing slow link adaptation is known in patent application WO 2019/162592 published on 29 Aug. 2019. The content of this patent application is included by reference.

An OMAMRC telecommunications system has M sources, optionally L relays and a destination, M≥2, L≥0 and a time-orthogonal multiple access scheme of the transmission channel that applies between the nodes taken from the M sources and L relays. The maximum number of time slots per frame transmitted is M+Tₘₐₓ with M slots allocated during a first phase to the successive transmission of the M sources and T_{used}≤Tₘₐₓ slots for one or more cooperative transmissions allocated during a second phase to one or more nodes selected by the destination according to a selection strategy.

The considered OMAMRC transmission system comprises at least two sources, each of which being able to operate at different times either exclusively as a source or as a relaying node. Optionally, the system can also include relays. The node terminology covers both a relay and a source acting as a relaying node or as a source. The considered system is such that the sources themselves can be relays. A relay differs from a source in that it has no message of its own to transmit, i.e. it simply retransmits messages from other nodes.

The links between the different nodes in the system are subject to slow fading and to white Gaussian noise. Knowledge of all the links in the system (CSI: Channel State Information) by the destination is not available. Indeed, the links between sources, between relays, between relays and sources are not directly observable by the destination, and their knowledge by the destination would require an excessive exchange of information between the sources, the relays and the destination. To limit the cost of feedback overhead, only one item of information about channel distribution/statistics (CDI: Channel Distribution Information) of all the links, e.g. average quality (e.g. average SNR, average SINR) of all the links, is assumed to be known by the destination in order to determine the bitrates allocated to the sources.

Link adaptation is of the slow type, i.e. before any transmission, the destination allocates initial bitrates to the sources knowing the distribution of all the channels (CDI: Channel Distribution Information). In general, CDI distribution can be traced back based on the knowledge of the average SNR or SINR of each link in the system.

Transmissions of messages from the sources are divided into frames during which the CSIs of the links are assumed to be constant (slow fading hypothesis). Bitrate allocation is not supposed to change for several hundred frames, it only changes when the CDI changes.

The method distinguishes three phases, an initial phase and, for each frame to be transmitted, a 1^{st} phase and a 2^{nd} phase. The transmission of a frame is done in two phases, which are optionally preceded by an additional phase referred to as initial phase.

During the initialisation phase, the destination determines an initial bitrate for each source, taking into account the average quality (e.g. SNR) of each of the links in the system.

The destination estimates the quality (e.g. SNR) of the direct links: source to destination and relay to destination, using known techniques based on the use of reference signals. The quality of the source-source, relay-relay and source-relay links is estimated by the sources and the relays based on the use of reference signals, for example. The sources and the relays transmit the average quality of the links to the destination. This transmission takes place before the initialisation phase. As only the average value of the quality of a link is taken into account, it is refreshed on a long time scale, i.e. over a time that allows to average out the fast fading in the channel. This time is of the order of the time required to cover several tens of wavelengths of the transmitted signal frequency for a given speed. The initialisation phase occurs, for example, every 200 to 1000 frames. The destination forwards the initial bitrates it has determined to the sources via a feedback path. The initial bitrates remain constant between two occurrences of the initialisation phase.

During the first phase, the M sources successively transmit their message during the M time slots, respectively using modulation and coding schemes determined from the initial bitrates. During this phase, the number N₁ of channel uses (i.e. resource elements according to 3GPP terminology) is fixed and identical for each of the sources.

During the second phase, messages from the sources are transmitted co-operatively by the relays and/or by the sources. This phase lasts Tₘₐₓ time slots at the most. During this phase, the number N₂ of channel uses is fixed and identical for each node (sources and relays).

The independent sources broadcast during the first phase, their coded information sequences in the form of messages to a single recipient. Each source broadcasts its messages at the initial bitrate. The destination communicates its initial bitrate to each source via strictly limited feedback control channels. Thus, during the first phase, the sources each transmit their respective message in turn during “time slots”, each dedicated to one source.

Sources other than the transmitting one, and optionally relays, of the “Half Duplex” type receive successive messages from the sources, decode them and, if selected, generate a message only from the messages from the sources that were decoded without error.

The selected nodes then access the channel orthogonally in time during the second phase to transmit their generated message to the destination.

The destination can choose which node to transmit at a given time.

Although such a solution makes it possible to maximise the average spectral efficiency (utility metric) within the considered system while respecting an individual quality of service (QOS) per source, it is advisable to try to further improve the decoding performance of a given source.

The present development meets this objective.

### SUMMARY

To this end, the object of the present development is a transmission method for an OMAMRC telecommunications system with M sources (S₁, . . . , S_{M}), optionally L relays (r₁, . . . , r_{L}) and a destination (d), with M≥2, L≥0, comprising a first phase during which the destination receives successive transmissions from the M sources of a message corresponding to a first redundancy (RV0) which is a codeword and a second phase comprising the following steps implemented by the destination (d):
broadcasting a message identifying one or more sources for which it has not decoded without error said transmitted message, referred to as undecoded sources,
   receiving at least one identifier from at least one source sᵢ not decoded by the destination transmitted by a set of nodes comprising at least one node taken from the M sources and L relays, that decoded without error said message transmitted by the source sᵢ,
   broadcasting a request for retransmitting said at least one message transmitted by the source sᵢ,
   reception of the same second redundancy of the message from the source sᵢ transmitted simultaneously by at least two nodes in the same time slot.

By enabling several nodes to simultaneously transmit the same redundancy for the same message from the same source in the same time slot, the development improves the known processes. Indeed, knowing that each node in the system has its own independent power budget, the present solution makes it possible to improve the decoding performance of a source sᵢ by proposing that all the nodes in the system that decoded without error a message transmitted by the source sᵢ according to a first redundancy simultaneously retransmit a second redundancy of this message i.e. using the same channel use. Thus, the equivalent transmission power for the source sᵢ is multiplied by the number of nodes in the system that have decoded without error a message transmitted by the source sᵢ and are participating in the retransmission. The first and second redundancies may be identical, for example when a repeating code is used, or may not and may or may not include systematic bits.

In the present solution, it is specified that the first redundancy is a codeword. The fact that the first redundancy is a codeword makes it possible to trace back to the transmitted message because there is a unique correspondence between the codeword and the message, which requires a coding efficiency of less than or equal to 1.

According to a first implementation of the method of the development, the method also comprises a step of selecting said source sᵢ from a set of sources not decoded by the destination whose identifiers are received from the nodes, taken among the M sources and L relays, that decoded without error at least one message transmitted by said sources which were decoded by the destination.

Indeed, depending on the circumstances, several messages transmitted by different sources may not have been decoded without error by the destination. Rather than leaving the choice of the message to be encoded and transmitted by a node selected by the destination on the basis of messages decoded by this node and not decoded by the destination, as is the case in the state of the art, the destination imposes, in the present solution, the choice of the message and therefore of the source for which a retransmission is required by one or more nodes. Thus, all the nodes involved in this retransmission can collaborate by retransmitting the same redundancy of the same message without this retransmission being interfered with by the retransmission of another message by other nodes.

According to a second implementation of the method of the development, the source sᵢ selected is the source for which a signal-to-noise ratio associated with a composite transmission channel, consisting of all the transmission channels established between each of the nodes that decoded without error said message transmitted by said source sᵢ and the destination, is the highest.

By choosing the source for which the composite transmission channel has a high signal-to-noise ratio, the destination increases its chances of decoding without error the retransmitted message.

When each of the nodes that decoded without error said message transmitted by said source sᵢ knows the phase ϕ_{a,d} of the transmission channel linking it to the destination (d), each node transmits the second redundancy of said message transmitted by the source sᵢ modulated by a phase factor e^{-jϕ}^{_{a,d}}=h_{a,d}*/|h_{a,d}| with j²=−1 and where h_{a,d}*/|h_{a,d}| corresponds to the conjugate h_{a,d}* of the transmission channel had linking the node a to the destination (d) divided by its modulus |h_{a,d}|.

Such a transmission mode, referred to as “equal gain combining”, makes it possible to obtain, at the destination, a coherent combination of all the signals transmitted by the nodes that decoded without error the message transmitted by said selected source sᵢ.

An item of information about the phase factors e^{-jϕ}^{_{a,d}} of the nodes can be determined by the destination using pilot signals, then transmitted to each of the nodes during initialisation and the first phase, for example.

When the system comprises a first group of nodes that decoded without error said message transmitted by said source sᵢ knowing the phase ϕ_{a,d} of the transmission channel linking it to the destination (d) and a second group of nodes having decoded without error said message transmitted by said source sᵢ not knowing the phase ϕ_{a,d} of the transmission channel linking it to the destination (d), each node belonging to the first group transmits the second redundancy of said message transmitted by the source sᵢ modulated by a phase factor e^{-jϕ}^{_{a,d}}=h_{a,d}*/|h_{a,d}| with j²=−1 and each node belonging to the second group transmits the redundancy of said message transmitted by the source sᵢ without phase modulation.

This is the case, for example, in a transitional period during which the destination has not yet been able to determine the item of information relating to the phase factors e^{-jϕ}^{_{a,d}} for all the nodes. Over time, the destination will be able to provide such an item of information to all the nodes in the system, further improving transmission quality.

In another implementation of the present solution, the messages intended to be transmitted by the M sources (s₁, . . . , s_{M}) are encoded using an incremental redundancy code and segmented into a plurality of redundancy blocks.

The development also relates to a system comprising M sources (s₁, . . . , s_{M}), L relays (r₁, . . . , r_{L}) and a destination (d), M≥2, L≥0, for implementing a transmission method according to one of the preceding purposes.

The purpose of the development is also a computer program product comprising program code instructions for implementing a method according to the development, as described previously, when it is executed by a processor.

The purpose of the development is also a computer-readable storage medium on which is saved a computer program comprising program code instructions for implementing the steps of a method according to the development as described above.

Such a storage medium can be any entity or device able to store the program. For example, the medium can comprise a storage means, such as a ROM, for example a CD-ROM or a microelectronic circuit ROM, or a magnetic recording means, for example a USB flash drive or a hard drive.

On the other hand, such a storage medium can be a transmissible medium such as an electrical or optical signal, that can be carried via an electrical or optical cable, by radio or by other means, so that the computer program contained therein can be executed remotely. The program according to the development can be downloaded in particular on a network, for example the Internet network.

Alternatively, the storage medium can be an integrated circuit in which the program is embedded, the circuit being adapted to execute or to be used in the execution of the method of the above-mentioned development.

### BRIEF DESCRIPTION OF THE DRAWINGS

Other purposes, features and advantages of the development will become more apparent upon reading the following description, hereby given to serve as an illustrative and non-restrictive example, in relation to the figures, among which:

FIG. 1 shows a embodiment of the development described in the context of an OMAMRC system,

FIG. 2 shows a transmission cycle of a frame,

FIG. 3 shows the various stages of the transmission method described in the development implemented by the system of FIG. 1,

FIG. 4 shows a circular buffer used to select a redundancy of the message to be transmitted,

FIG. 5 shows a destination belonging to an OMAMRC telecommunication system with M sources, optionally L relays and a destination, M≥2, L≥0 according to an embodiment of the development.

### DETAILED DESCRIPTION OF CERTAIN ILLUSTRATIVE EMBODIMENTS

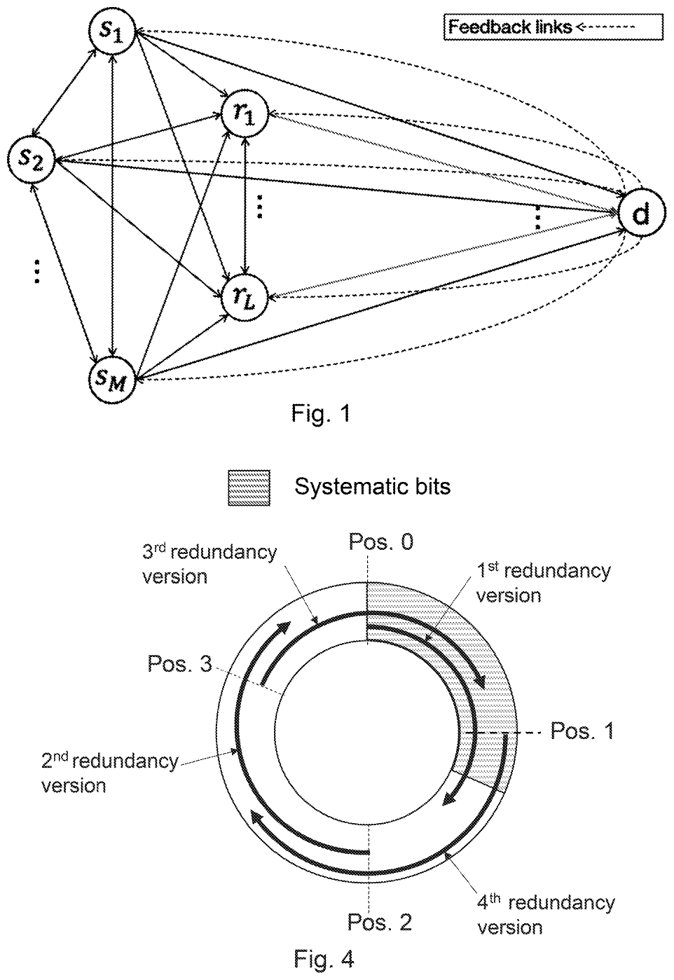

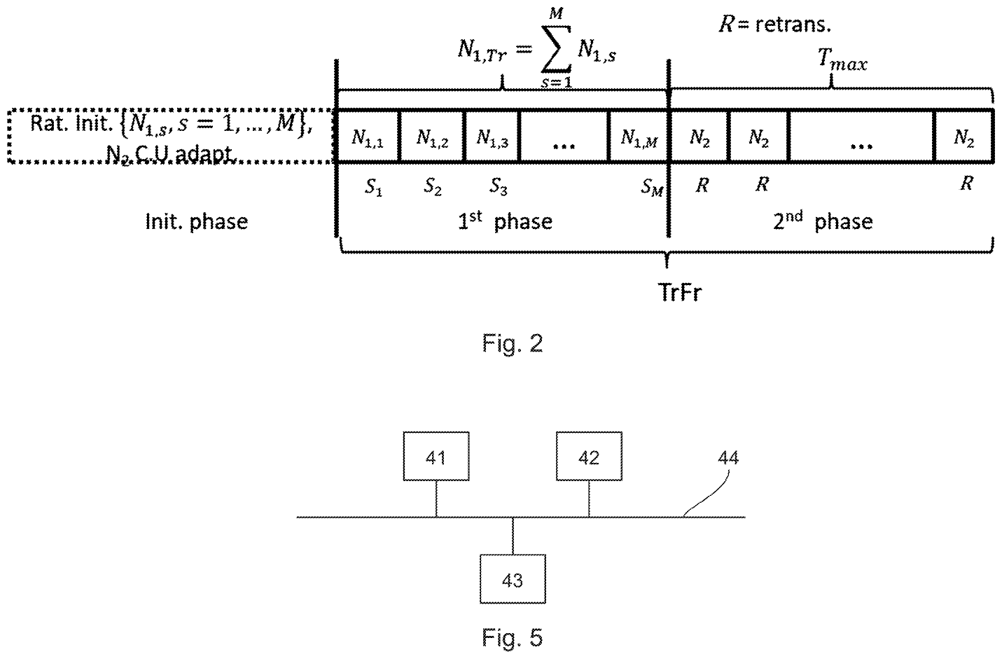

In relation to FIG. 1, an embodiment of the development described in the context of an OMAMRC system in support of the diagram in [FIG. 2] which illustrates a transmission cycle of a frame is now presented.

This system includes M sources belonging to the source set [symbol] ={s₁, . . . , s_{M}}, L relays that belong to the relay set [symbol] ={r₁, . . . , r_{L}} and a destination d. By convention, it is assumed that sᵢ=i∀i∈{1, . . . , M} and rᵢ=M+i∀i∈{1, . . . , L}.

Every source in the set S communicates with the single destination with the help of the other sources (user cooperation) and the relays that cooperate.

As a simplification of the description, the following assumptions are then made about the OMAMRC system:
the sources, the relays are equipped with a single transmitting antenna;
the sources, the relays and the destination are equipped with a single reception antenna;
the sources, the relays and the destination are perfectly synchronised;
the sources are statistically independent (there is no correlation between them);
all nodes transmit with the same power;
an assumed CRC code included in the K_{S} information bits of each source s to determine whether or not a message was correctly decoded;
the links between the different nodes suffer from additive noise and fading. The fading gains are fixed during the transmission of a frame for a maximum duration of M+Tₘₐₓ time slots, but may change independently from frame to frame. Tₘₐₓ≥2 is a system parameter;
the instantaneous quality of the channel/direct link in reception (CSIR Channel State Information at Receiver) is available at the destination, sources and relays;
the returns are error-free (no errors on the control signals).

Nodes include relays and sources which can behave like a relay when they are not transmitting their own message.

The nodes, M sources and L relays access the transmission channel according to a multiple access scheme orthogonal in time, or frequency, which enables them to listen to the transmissions of the other nodes without interference. The nodes operate in a “half-duplex” mode.

The following notations are used:
Hᵢ is the set of nodes a that decoded without error the message u; transmitted by the source sᵢ during a time slot in the first phase.
x_{a,k}∈ [symbol] is the modulated symbol coded for use on channel k transmitted by the node a∈ [symbol] ∪U [symbol] ,
y_{a,b,k} is the signal received at the node b∈ [symbol] ∪ [symbol] ∪{d}\{a} corresponding to a signal transmitted by the node a∈ [symbol] ∪ [symbol] ,
yₛ_{ᵢ}_{,b,k} is the signal received at the node b∈ [symbol] ∪ [symbol] ∪{d}\Hᵢ corresponding to the signals transmitted by the nodes a∈Hᵢ,
γ_{a,b} is the average signal-to-noise ratio (SNR) which takes into account the effects of path-loss and shadowing,
h_{a,b} is the channel fading gain, which follows a symmetrical circular complex Gaussian distribution with zero mean and variance γ_{a,b} (the received power is proportional to the transmitted power), the gains are independent of each other, n_{a,b,k} or nₛ_{ᵢ}_{b,k} are samples of a white Gaussian noise (AWGN) samples distributed following an identical and independent way that follow a complex Gaussian distribution of circular symmetry with zero mean and unitary variance.
Rₛ is a variable representing the initial bitrate of the source which can take its values in the finite set {R̅₁, . . . , R̅ₙ_{_{MCS}}}. Similarly, αₛ is a variable representing the ratio N₂/N_{1,s} which can take its values in a finite set A={α̅₁, . . . , α̅_{|A|}}.

The signal received at the node b∈ [symbol] ∪ [symbol] ∪{d}\{a} corresponding to the signal transmitted by the node a∈ [symbol] during the first phase can be written as:

$${y}_{a , b , k} = {h}_{a , b} {x}_{a , k} + {n}_{a , b , k} \qquad ( 1 )$$

The signal received at the node b∈ [symbol] ∪ [symbol] ∪{d} \Hᵢ corresponding to the signals transmitted by the nodes belonging to the set Hᵢ during the second phase can be written as:

$${y}_{{s}_{i} , b , k} = {( {\sum }_{a ∈ {H}_{i}} {h}_{a , b} {e}^{- j {φ}_{a , d}} )}_{{x}_{k}} + {n}_{{s}_{i} , b , k} \qquad ( 2 )$$

where xₖ=x_{a,k}∀a∈Hᵢ, i.e. the same version of redundancy on the message sᵢ is transmitted by all the nodes α∈Hᵢ, and φ_{a,d} is a phase correction term with respect to the channel h_{a,d} with j²=−1.

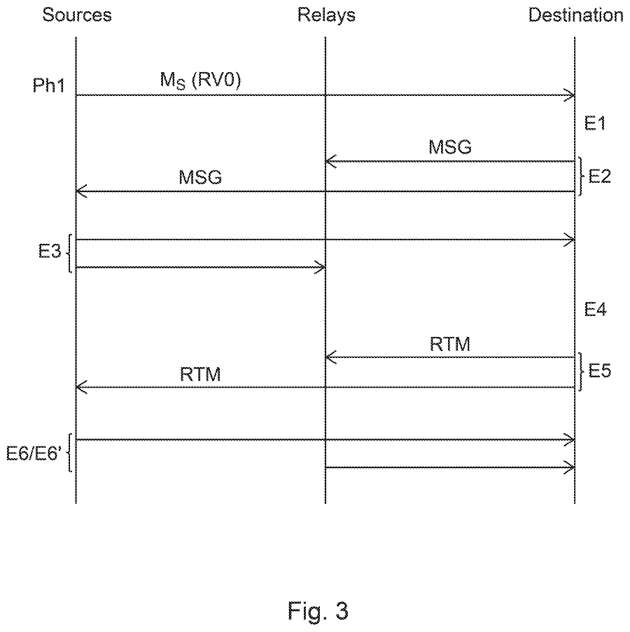

FIG. 3 shows the various stages of the transmission method covered by the development implemented by the system described above.

During an initial Ph1 phase of M time slots, each source s E [symbol] transmits at least one message corresponding to a first redundancy RV0 which is a codeword during N_{1,s} channel uses, k∈{1, . . . , N_{1,s}}, the number N_{1,s} of channel uses depends on the source s.

By using reference signals (pilot symbols, SRS signals from 3GPP LTE, etc.), the destination can determine the gains (CSI Channel State Information) of the direct links: h_{dir}={hₛ_{₁}_{,d}, . . . , hₛ_{_{M}}_{,d}, . . . , hᵣ_{_{L}}_{,d}}, i.e. source-to-destination and relay-to-destination links, and can therefore deduce the average SNRs of these links.

However, the gains of links between sources, links between relays and links between sources and relays are not known to the destination. Only sources and relays can estimate a metric for these links by using reference signals in a similar way to that used for direct links. Given that the statistics of the channels are assumed to be constant between two initialisation phases, the transmission of metrics to the destination by the sources and relays may only occur at the same bitrate as the initialisation phase. The channel statistic for each link is assumed to follow a centred circular complex Gaussian distribution and the statistics are independent between links. It is therefore sufficient to consider only the average SNR as a measure of the statistic of a link.

The sources and relays therefore forward metrics representative of the average SNRs of the links they can observe to the destination.

The destination thus knows the average SNR of each link.

During an initial phase of link adaptation (not shown in the figures) which precedes the transmission of several frames, the destination transmits for each source s a value representative (index, MCS, bitrate, etc.) of an initial bitrate R̅ᵢ and a value \tilde{α}ᵢ.

Each of the initial bitrates unambiguously determines an initial modulation and coding scheme (MCS) or, vice versa, each initial MCS determines an initial bitrate.

The forwarding of initial bitrates Ri and reports α̅ᵢ are transmitted via very limited feedback control channels.

Each source transmits its framed messages to the destination using the other sources and relays.

A frame occupies time slots when transmitting the M messages of the respectively M sources. The transmission of a frame (which defines a transmission cycle) takes place over M+T_{used} time slots: M slots for the first phase with respective capacities N_{1,i} channel uses for each source i, T_{used} slots for a second phase which will be described later in this document.

Still during the first phase, each source s∈ [symbol] transmits after coding a message uₛ, corresponding to a first RV0 redundancy, representing Kₛ information bits uₛ∈ [symbol] ₂^{K}^{ₛ}, [symbol] ₂ being the two-element Galois field. The message uₛ includes a CRC code which is used to check the integrity of the message uₛ. The message uₛ is coded according to the initial MCS. Given that the initial MCSs may differ between sources, the lengths of the coded messages may differ between sources.

The applied coding uses, for example but not exclusively, an incremental redundancy code which can be based on existing codes such as convolutional code, turbo code, LDPC, etc.

The principle of this type of code is as follows: a message transmitted by each source is encoded (the message may be segmented into several independently encoded sub-blocks if the message is too long) by a very low-efficiency mothercode (⅓, for example). The coded bits are then placed in a circular buffer shown in FIG. 4 having several reading start positions Pos. 0, Pos. 1, Pos. 2 and Pos. 3. Such a circular buffer contains the coded bits of a message from a source coded by a systematic low-efficiency mothercode and making it possible to select a particular redundancy of the message to be transmitted according to a reading start position in the circular buffer.

These reading start indexes Pos. 0, Pos. 1, Pos. 2 and Pos. 3 correspond to different redundancy blocks/versions, in the example chosen there are four possible redundancy versions. For each redundancy block/version, a node will read the number of coded bits to be sent, corresponding to the number of channel uses available for a given modulation and message size, from the corresponding redundancy position by moving in the circular buffer in the direction of the initial fill. The selected coded bits are then interleaved and modulated. Whether or not the incremental redundancy code is of the systematic type, it is such that the first version of the redundancy block/version can be decoded independently of the other blocks/versions.

In the first phase, the M sources successively transmit their message uₛ corresponding to the first RV0 redundancy during the M slots with respectively modulation and coding schemes determined from the initial bitrate values.

Each transmitted message uₛ corresponds to a source s∈ [symbol] , a correctly decoded message is assimilated to the corresponding source by abuse of notation.

When a source is transmitting, the other sources and relays listen and try to decode the messages received at the end of each time slot.

In a second phase comprising steps E1 to E6, the destination determines in a step E1 whether or not the received messages have been successfully decoded using the CRC.

In the second phase, the selected node, source or relay, acts as a relay by cooperating with the sources to help the destination correctly decode the messages from all the sources. The selected node transmits i.e. cooperates by transmitting a redundancy version of a message from a source that it has correctly decoded. The second phase comprises a maximum of Tₘₐₓ time slots called rounds. Each round t∈{1, . . . , Tₘₐₓ} has a capacity of N₂ channel uses.

If all the sources are decoded correctly, the destination broadcasts a message of the ACK type. In this case, a transmission cycle of a new frame begins with the clearing of the memories of the relays and destination and with the transmission by the sources of new messages.

If the decoding of at least one source is incorrect, in a step E2, the destination broadcasts one or more messages MSG identifying the source or sources for which it has not decoded without error the transmitted message. Such sources are referred as undecoded sources.

Such messages broadcast by the destination include, in a first implementation, identifiers of sources for which the destination has decoded without error the transmitted message. In this first implementation, the nodes intercepting the broadcast messages determine the sources for which the destination has not decoded without error the transmitted message.

In a second implementation, the messages broadcast by the destination include identifiers of the sources for which the destination has not decoded without error the transmitted message. In this second implementation, the nodes intercepting the broadcast messages immediately know the identity of the sources for which the destination has not decoded without error the transmitted message.

The destination informs the nodes using a limited feedback control channel to transmit messages MSG. These messages MSG are based on the decoding result of the messages received by the destination. The destination thus controls the transmission of the nodes using these messages MSG, which improves spectral efficiency and reliability by increasing the probability of all sources being decoded by the destination.

Upon receiving of a message MSG, each node a∈ [symbol] ∪ [symbol] transmits to the destination, in a step E3, at least one identifier of at least one source for which it has correctly decoded the message uₛ transmitted at the end of the preceding time slot (round) noted S_{a,t-1} and such that this message was not decoded correctly by the destination at the end of the previous round.

By convention, S_{b,t}⊂ [symbol] is the set of messages (or sources) correctly decoded by the node b∈ [symbol] ∪ [symbol] ∪{d} at the end of the time slot t (round t), t∈{0, . . . , Tₘₐₓ}. The end of the time slot (round) t=0 corresponds to the end of the first phase. The number of time slots used during the second phase T_{used}={1, . . . , Tₘₐₓ} depends on the success of the decoding at the destination.

During a step E4, the destination selects the source st for which a retransmission is required. Such a source sᵢ is selected from the set of sources correctly decoded by the nodes∈ [symbol] ∪ [symbol] ∪{d} but not by the destination at the end of the time slot t (round t), t∈{0, . . . , Tₘₐₓ}.

Thus, rather than leaving the choice of message to the nodes that have decoded without error a message transmitted by a source, the destination imposes the choice of message and therefore of the source for which a retransmission is required.

In an initial implementation, the source sᵢ selected by the destination is the source for which a signal-to-noise ratio SNRᵢ associated with a composite transmission channel, (Σ_{a∈H}_{ᵢ}h_{a,d} e^{-jφ}^{_{a,d}}) with φ_{a,d}=0∀a∈Hᵢ, established directly between each of the nodes that decoded without error the transmitted message uᵢ by the source sᵢ and the destination, is the highest.

By choosing the source for which the composite transmission channel has a high signal-to-noise ratio, the destination increases its chances of decoding without error the message uᵢ when it is retransmitted.

In a step E5, once the source sᵢ for which a retransmission is required, the destination broadcasts a retransmission request RTM including an identifier of the source sᵢ.

In this first implementation, the signal-to-noise ratio SNRᵢ of the composite transmission channel is given by:

$${SNR}_{i} = {\vert {\sum }_{a ∈ {H}_{i}} \vert {h}_{a , d} \vert \vert}^{2} / {N}_{0}$$

where N₀ is the spectral density of noise and interference and had is the transmission channel of the node a to the destination and Hᵢ is the set of nodes a that have decoded without error the message uᵢ transmitted by the source sᵢ.

In a particular implementation of the present transmission method, when each of the nodes a that have decoded without error the message uᵢ transmitted by the source sᵢ knows the phase φ_{a,d} of the transmission channel h_{a,d} linking it to the destination (d), the signal-to-noise ratio SNRᵢ of the composite transmission channel is given by:

$${SNR}_{i} = {\vert {\sum }_{a ∈ {H}_{i}} \vert {h}_{a , d} \vert \vert}^{2} / {N}_{0}$$

Upon reception of the retransmission request, each node that has decoded without error the message uᵢ transmitted by the source sᵢ, in a step E6, transmits the same redundancy of said message uᵢ transmitted by the source sᵢ modulated by a phase factor e^{-jϕ}^{_{a,d}}=h_{a,d}*/|h_{a,d}| with j²=−1 and where h_{a,d}*/|h_{a,d}| corresponds to the conjugate had of the transmission channel had linking node a to the destination (d) divided by its modulus |h_{a,d}| in the same time slot so that all these redundancies transmitted by these nodes are received at the same time by the destination in a coherent manner. Thus, the composite channel in this case is expressed as (Σ_{a∈H}_{ᵢ}h_{a,d} e^{-jφ}^{_{a,d}})=(Σ_{a∈H}_{ᵢ}h_{a,d}e^{-jϕ}^{_{a,d}})=Σ_{a∈H}_{ᵢ}|h_{a,d}|.

Such a transmission mode, referred to as “equal gain combining”, makes it possible to obtain, on the destination side, a coherent combination of all the signals transmitted by the nodes that decoded without error said message transmitted by said selected source sᵢ.

The redundancy of the message transmitted by each node that decoded without error the message uᵢ sent by the source sᵢ is the same for each of these nodes. Such redundancy may be the RV0 redundancy transmitted during the first PH1 phase or any other redundancy in the message uᵢ.

In another particular implementation of the present transmission method, the system comprises a first group Aᵢ of nodes that have decoded without error said message transmitted by said source sᵢ knowing the phase ϕ_{a,d} of the transmission channel linking it to the destination (d) and a second group Bᵢ of nodes that have decoded without error said message transmitted by said source sᵢ not knowing the phase ϕ_{a,d} of the transmission channel linking it to the destination (d), the signal-to-noise ratio SNR; of the composite transmission channel is given by:

$${SNR}_{i} = {( {\sum }_{a ∈ {A}_{i}} \vert {h}_{a , d} \vert + {\sum }_{a ∈ {B}_{i}} {h}_{a , d} )}^{2} / {N}_{0}$$

where Hᵢ=Aᵢ∪Bᵢ.

Upon reception of the retransmission request, each node belonging to the first group transmits, in a step E6′, the same redundancy of the message transmitted by the source sᵢ modulated by a phase factor e^{-jϕ}^{_{a,d}}=h_{a,d}*/|h_{a,d}| with j²=−1, and each node belonging to the second group transmits the same redundancy of said message transmitted by the source sᵢ without phase modulation in the same time slot so that all these redundancies transmitted by these nodes are received at the same time by the destination.

This is the case, for example, in a transitional period during which the destination has not yet been able to determine the item of information relating to the phase factors e^{-jϕ}^{_{a,d}} for all the nodes. Over time, the destination will be able to provide such an item of information to all the nodes in the system, further improving transmission quality.

In this implementation too, the message redundancy transmitted by each node that has decoded without error the message uᵢ sent by the source sᵢ is the same for each of these nodes. Such redundancy may be the RV0 redundancy transmitted during the first PH1 phase or any other redundancy in the message uᵢ. The transmission of redundancies can follow a predefined order of reading start positions of the circular buffer for a message from a repeating source. For example, with reference to FIG. 4 for 4 redundancy blocks/version, a systematic LDPC code and N_{1,s}=N₂∀s∈ [symbol] the order can be Pos. 0, Pos. 2, Pos. 3, Pos. 1 and so on with RV0 and RV3 the redundancy versions associated with Pos. 0 and Pos. 3 which can be decoded independently of other blocks/versions (each second transmission is self-decodable).

FIG. 5 shows a destination belonging to an OMAMRC telecommunication system with M sources, optionally L relays and a destination, M≥2, L≥0 according to one embodiment of the development. Such a destination is able to implement the transmission method according to FIG. 3.

A destination may comprise at least one hardware processor 51, a storage unit 52 and at least one network interface 53 which are connected to each other via a bus 54. Naturally, the components of the destination can be connected by means of a connection other than a bus.

The processor 51 controls the operations of the destination. The storage unit 52 stores at least one program for implementing the method according to one embodiment of the development to be executed by the processor 51, and various data, such as parameters used for calculations performed by the processor 51, intermediate data for calculations performed by the processor 51, etc. The processor 51 may be formed by any known and appropriate hardware or software, or by a combination of hardware and software. For example, the processor 51 can be formed by a dedicated hardware such as a processing circuit, or by a programmable processing unit such as a central processing unit which executes a program stored in a memory thereof.

The storage unit 52 may be formed by any appropriate means capable of storing the program or programs and data in a computer-readable manner. Examples of storage devices 52 include non-transitory computer-readable storage media such as semiconductor memory devices, and magnetic, optical or magneto-optical recording media loaded into a read/write device.

The network interface 53 provides a connection between the destination and the set of nodes E [symbol] U [symbol] .

1. A communication method for an N-node telecommunication system with M sources (S₁, . . . , S_{M}), N−M relays and a destination (d), where N≥M≥2, comprising a first phase during which the destination receives successive transmissions from the M sources of a message corresponding to a first redundancy (RV0) which is a codeword and a second phase comprising the following implemented by the destination (d):
broadcasting a message identifying one or more sources for which it has not decoded without error the transmitted message, referred to as undecoded sources,
reception of at least one identifier from at least one source sᵢ not decoded by the destination transmitted by a set of nodes comprising at least one node that decoded without error the message transmitted by the source sᵢ,
broadcasting a request for retransmitting the at least one message transmitted by the source sᵢ, and
reception of the same second redundancy of the message from the source sᵢ transmitted simultaneously by at least two nodes in the same time slot.

2. The communication method according to claim 1, wherein the first and second redundancy versions are different.

3. The communication method according to claim 1, further comprising selecting the source sᵢ from a set of undecoded sources whose identifiers are received from the nodes that decoded without error at least one message transmitted by the undecoded sources to the destination.

4. The communication method according to claim 2, wherein the selected source sᵢ is the source for which a signal-to-noise ratio associated with a composite transmission channel, consisting of all the transmission channels established between each of the nodes that decoded without error the message transmitted by the source sᵢ and the destination, is the highest.

5. The communication method according to claim 1, wherein, when each of the nodes that decoded without error the message transmitted by the source sᵢ knows the phase Φ_{a,d} of the transmission channel linking it to the destination (d), each node transmits the second redundancy of the message transmitted by the source sᵢ modulated by a phase factor e^{-jΦ}^{_{a,d}}=h_{a,d}*/|h_{a,d}| with j²=−1 and where h_{a,d}*/|h_{a,d}| corresponds to the conjugate h_{a,d}* of the transmission channel h_{a,d} linking node a to the destination (d) divided by its modulus |h_{a,d}|.

6. The communication method according to claim 4, wherein, a first group of nodes that decoded without error the message transmitted by the source sᵢ knowing the phase Φ_{a,d} of the transmission channel linking it to the destination (d) and a second group of nodes that decoded without error the message sent by the source sᵢ not knowing the phase Φ_{a,d} of the transmission channel linking it to the destination (d), each node belonging to the first group transmits the second redundancy of the message transmitted by the source sᵢ modulated by a phase factor e^{-jΦ}^{_{a,d}}=h_{a,d}*/h_{a,d} with j²=−1, and each node belonging to the second group transmits the redundancy of the message transmitted by the source sᵢ without phase correction.

7. The communication method according to claim 1, wherein the messages intended to be transmitted by the M sources (S₁, . . . , S_{M}) are coded using an incremental redundancy code and segmented into a plurality of redundancy blocks corresponding to different redundancy versions.

8. A system comprising N nodes with M sources (S₁, . . . , S_{M}), N−M relays and a destination (d), N≥M≥2, for implementing the communication method according to claim 1.

9. A processing circuit comprising a processor and a memory, the memory storing program code instructions of a computer program for implementing the transmission method according to claim 1, when the computer program is executed by the processor.
